(19) United States
(12) Patent Application Publication
(10) Pub. No.: US 2006/0209208 A1
(43) Pub. Date: Sep. 21, 2006

(54) On screen display apparatus and method for displaying menu

(75) Inventors: Yun-sung Kim, Seoul (KR); Sang-hee Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/334,566

(22) Filed: Jan. 19, 2006

(30) Foreign Application Priority Data
Mar. 15, 2005 (KR) 2005-21443

(51) Int. Cl. H04N 11/00

(52) U.S. Cl. 348/468

(57) ABSTRACT

An on screen display apparatus and a method for displaying menus of the on screen display apparatus are provided. An on screen display apparatus includes a memory device for storing data and system programs for a first area, including first menu items; a screen device; an input device for generating a signal; and a control device for dividing the first area into a first sub-area and a second sub-area and for displaying the first sub-area more brightly than the second sub-area if one of the first menu items is located in the first sub-area. The method includes storing data and system programs for a first area, including first menu items; generating a signal; and dividing the first area into a first sub-area and a second sub-area and displaying the first sub-area more brightly than the second sub-area if one of the first menu items is located in the first sub-area.

### CROSS-REFERENCE TO RELATED APPLICATION

This application claims benefit under 35 U.S.C. § 119 from Korean Patent Application No. 2005-21443 filed Mar. 15, 2005 with the Korean Intellectual Property Office, the entire content of which is incorporated herein by reference.

### BACKGROUND OF THE INVENTION

1. Field of the invention

The present invention generally relates to an on screen display (OSD) apparatus and a method for displaying a menu of the on screen display apparatus, and more particularly to an on screen display apparatus and a method for displaying a menu of the on screen display apparatus to a user more efficiently by providing the menu with a highlighting and an animation effect.

2. Description of the Related Art:

An on screen display apparatus is included within a video equipment having a screen device and displays required information for operating the video equipment. Examples of video equipment having the on screen display apparatus are television receivers, video cassette recorders, automatic teller machines (ATMs), computers, and other such devices known in the art. Hereinafter, a conventional method will be described for displaying a menu in an on screen display apparatus that is broadly used in a television receiver.

According to a conventional method for displaying a menu in an on screen display apparatus embedded in a television receiver, the user operates input devices, such as an operation panel or a remote controller, to select a desired function from menus, thereby displaying main menus on the screen, sequentially. These main menus usually include option items that can be selected in the TV receiver or items capable of adjusting a function of the TV receiver. Subsequently, if the user utilizes an operation panel or a remote controller to select one of the main menu items, sub-items of the selected main menu items are displayed on the screen.

In selecting main menu items according to such a conventional method, for each main menu item, only a simple title is displayed. Thus, it is difficult for the user to see what is being selected, i.e. whether the underlying items are options of the TV receiver or functions to be adjusted. Therefore, in order to set eventual desired options or functions, the user must find a desired menu item and select and move through each main menu item repeatedly.

Also, generally, both menu items that the user intends to select and other non-selected menu items are displayed with highlight effects. Because main menu items and submenu items are displayed by applying the same highlight effects, it is difficult for the user to concentrate on menu items that the user intends to select. Thus, the usefulness of using highlighting effects is diminished and causes inconvenience to the user.

### SUMMARY OF THE INVENTION

Apparatuses and methods consistent with the present invention are provided to display a menu for a user so that the user is able to select corresponding items more efficiently by providing the menu with a highlighting and an animation effect.

According to an exemplary embodiment of the present invention, there is provided an on screen display apparatus. The apparatus includes a memory device which is configured to store data and system programs for a first area, the data including a plurality of a first menu items; a screen device which is configured to display said first area; an input device which is configured to generate a signal to display said first area to said screen device; and a control device which is configured to divide said first area into a first sub-area and a second sub-area using said system programs according to said signal and to display the first sub-area more brightly than the second sub-area if at least one of the plurality of the first menu items is located in said first sub-area.

In the case of at least one of the plurality of said first menu items being located in said first sub-area, said control device displays help for the at least one first menu item which is located in said first sub-area.

In addition, in the case of at least one of the plurality of said first menu items being located in said first sub-area, said control device may display at least one sub-menu item for the at least one first menu item which is located in said first sub-area.

Furthermore, said control device shifts said plurality of the first menu items according to a shift signal of said input device.

In the case where at least one of the plurality of said first menu items is located in said first sub-area, said control device displays the at least one first menu item which is located to said first sub-area with animation effects.

In accordance with another exemplary embodiment of the present invention, a method for displaying menus on an on screen display apparatus is provided. The method includes storing data and system programs for a first area, the data including a plurality of a first menu items; generating a signal; and dividing said first area into a first sub-area and a second sub-area according to said signal and displaying the first sub-area more brightly than the second sub-area if at least one of the plurality of the first menu items is located in said first sub-area.

The method may further comprise displaying help for the at least one first menu item which is located in said first sub-area.

In addition, the method may further comprise displaying at least one sub-menu item for the at least one first menu item which is located in said first sub-area.

Furthermore, the method may further comprise shifting said plurality of the first menu items according to a shift signal of said input device.

The method further may comprise displaying the at least one first menu item which is located in said first sub-area with animation effects.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram of a TV receiver having an on screen display apparatus according to an exemplary embodiment of the present invention;

FIG. 2 is a diagram showing a remote controller as an exemplary input device of the TV receiver shown in FIG. 1;

FIG. 3 is a flow chart showing display processes of menu items according to an exemplary embodiment of the present invention;

FIG. 4 and FIG. 5 are screen shots showing how menu items are displayed to a screen of the screen device according to an exemplary embodiment of the present invention;

FIG. 6 and FIG. 7 are diagrams showing the subdividing of a screen displayed to a screen device into different areas, according to an exemplary embodiment of the present invention;

FIG. 8A and 8B are diagrams showing the displaying of a portion of menu items to a screen of a screen device according to an exemplary embodiment of the present invention; and;

FIG. 9 is a diagram showing the displaying of changing a setting of the volume according to an exemplary embodiment of the present invention.

### DETAILED DESCRIPTION OF THE EXEMPLARY EMBODIMENTS OF THE PRESENT INVENTION

Hereinafter, exemplary embodiments of the present invention are described in detail with reference to the drawings.

An on screen display apparatus and a method for displaying a menu on the on screen display apparatus according to an exemplary embodiment of the present invention are applicable to all video equipments, including such video equipment as TV receivers, video cassette recorders, automatic teller machines (ATMs), computers, and other video equipment known in the art. However, the example of a TV receiver will be used as the video equipment in the following description of exemplary embodiments of the present invention.

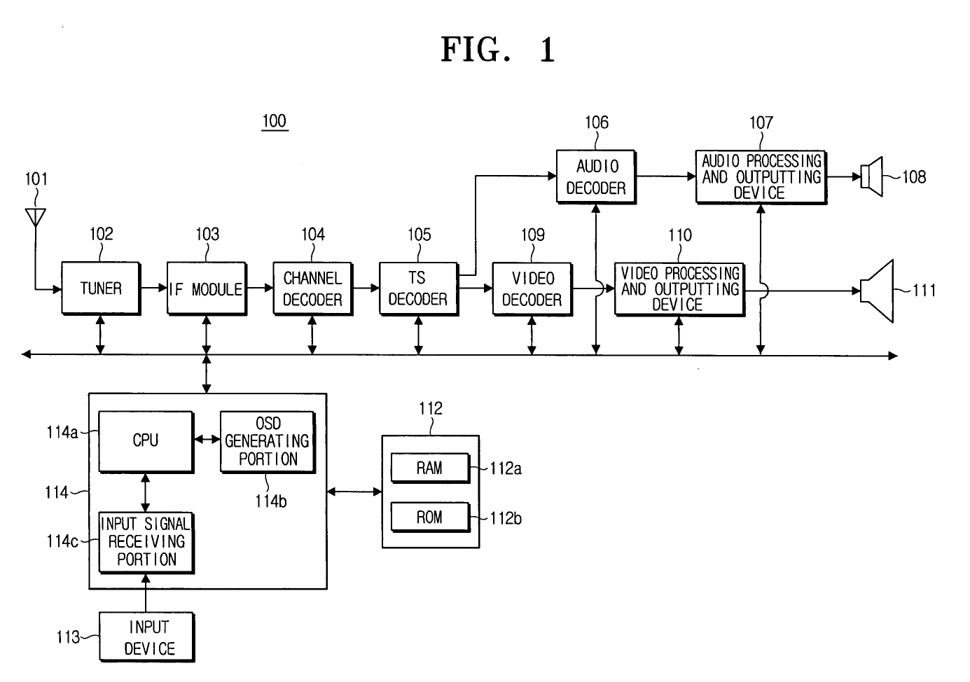

FIG. 1 is a block diagram of a TV receiver having an on screen display apparatus according to an exemplary embodiment of the present invention.

Referring to FIG. 1, a TV receiver 100 according to an exemplary embodiment of the present invention comprises an antenna 101, a tuner 102, an IF (Intermediate Frequency) module 103, a channel decoder 104, a TS (Transport Stream) decoder 105, an audio decoder 106, an audio processing and outputting device 107, a speaker 108, a video decoder 109, a video processing and outputting device 110, a screen device 111, a memory device 112, an input device 113 and a control device 114.

In FIG. 1, a memory device 112 is comprised of a RAM (Random Access Memory) 112a and a ROM (Read Only Memory) 112b. In addition, a control device 114 is comprised of a CPU (Central Processing Unit) 114a, a OSD (On Screen Display) generator 114b and an input signal receiver 114c.

Hereinafter, an operation according to a configuration of a TV receiver as shown in FIG. 1 will be described.

A tuner 102 inputs a TV broadcast signal being received via an antenna 101, then selects a channel according to the control of a CPU 114a and outputs an IF signal according to the selection. An IF module 103 converts the IF signal that is outputted from the tuner 102 to a baseband signal. A channel decoder 104 reproduces a data bit string by channel decoding a baseband signal outputted from the IF module 103. In addition, if external equipment (not shown) such as a camera or VCR (Video Cassette Recorder) is connected to the TV receiver 100, a data bit string for a video signal to be inputted from the external equipment may be reproduced.

A TS decoder 105 separates audio data and video data from the data bit string reproduced by the channel decoder 104. An audio decoder 106 receives audio data of the data separated from the TS decoder 105, and decodes the audio data according to a MPEG (Moving Picture Expert Group) specification or a Dolby AC-3 specification, or other specification known in the art. An audio processing and outputting device 107 receives the audio data decoded by the audio decoder 106 and processes the audio data, and thereafter outputs the audio data via speaker 108.

Meanwhile, a video decoder 109 receives video data of the data separated from the TS decoder 105, and decodes the video data according to a MPEG specification, or other specification known in the art.

A video processing and outputting device 110 receives the video data decoded by the video decoder 109 and converts and processes the video data in a state capable of being displayed, and thereafter outputs the video data via a screen device 111. In addition, it can make a mixed image by compounding an on screen display data which is made by an OSD generator 114b of the control device with the video data decoded by the video decoder 109, and can display this mixed image to the screen device 111. Wherein, the on screen display data is the data for which the control device 114 displays every kind of information in graphic or in a text on the screen of the screen device 111.

An input device 113 generates a signal according to an input state by inputting of a user, such as an operation panel equipped with a TV receiver or a remote controller, or other input device known in the art. Generally, an operation panel or a remote controller is equipped with a button for each finction, and a signal is generated by pushing the button by a user. As an example, if an input signal is for changing a channel, the CPU 114a of the control device adjusts the tuner 102 to tune different high frequency signals from the antenna 101 and to receive the corresponding TV broadcast signal.

If an input signal receiver 114c of the control device 114 receives an input signal by inputting of a user from the input device 113, the input signal receiver 114c sends the input signal to the CPU 114a, and the CPU 114a performs a corresponding program stored in a ROM 112b of the memory device 112 according to the input signal.

A memory device 112 is comprised of a ROM 112b for storing programs to perform an operation of the control device 114 and a RAM 112a for storing temporally data according to performing the operation of the control device 114. The memory device may further comprise an EEPROM (Electrically Erasable and Programmable ROM) or other such component known in the art for storing every kind of reference data.

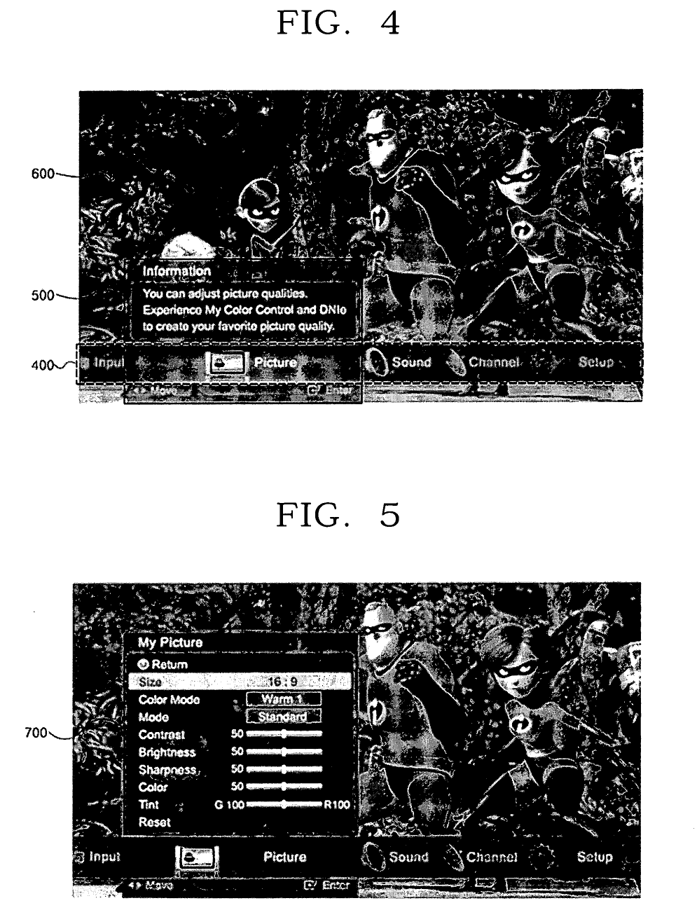

Hereinafter, an on screen display apparatus corresponding to an exemplary embodiment of the present invention will be described in detail with reference to FIG. 1 and FIG. 4 to FIG. 9.

Firstly, a memory device 112 as a storage device stores data for indicating a main menu area 400 for an on screen display, a help area 500 and a sub-menu area 700. Likewise, the memory device 112 stores data for providing a highlight effect for each area. The memory device 112 also stores data for a plurality of first menu items 410, 420, 430, 440, 450 included within the main menu area 400, and data for icons 411, 421, 431, 441, 451 and for text 412, 422, 432, 442, 452 to provide information for each the first menu items. The data for each icon of the first menu items includes data for representing an animation effect and the data for each text includes data for increasing or decreasing the brightness of the text. Additionally, the data for each text may also include data for increasing or decreasing the brightness around each text. Likewise, the memory device 112 stores data capable of increasing or decreasing the brightness of a number or a symbol beyond the text, or data capable of increasing or decreasing the brightness for an area around the number or symbol. In addition, the memory device 112 stores data for second menu items corresponding to sub-menu items for each of the first menu items and system programs for performing an operation of the control device 114. Furthermore, the memory device 112 may store data to provide help for each of the first menu items in a help area 500. Although it is not shown in the figures, the memory device 112 may also store data to provide help for each of the second menu items. Also, the memory device 112 includes data for each of the second menu items of the sub-menu area 700. Particularly, the memory device 112 stores data for each frame of the main menu area 400, a help area 500 and a sub-menu area 700. The corresponding menu items and help information are located inside each frame.

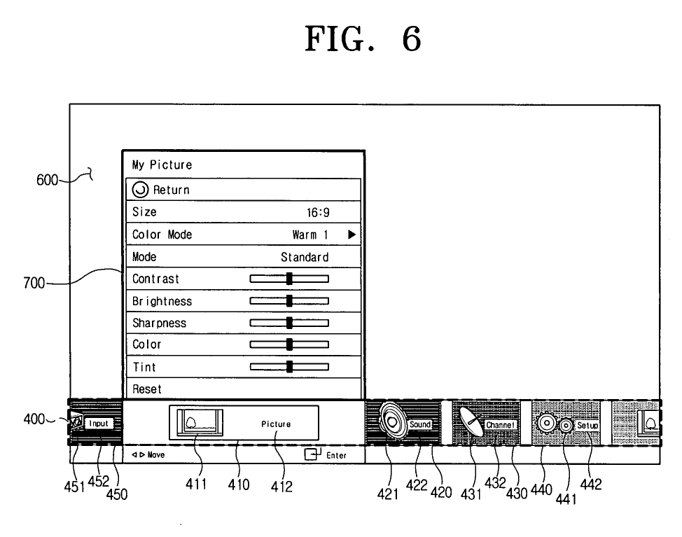

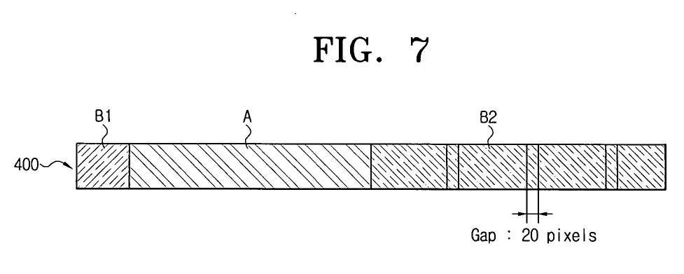

With reference to FIG. 7, the main menu area 400 can be again divided into three areas including a select area A, a first non-select area B1 and a second non-select area B2. The main menu area 400 may be located on the lower corner of the screen of the screen device 111. In addition, a select area A may occupy more than ⅓ of the area within the main menu area 400 and may occupy an area wider than at least one of non-select areas B1 and B2. On the other hand, each first menu item of the main menu area 400 is laid out horizontally, with one of the first menu items being located on the select area A and at least one of the first menu items being located on the non-select areas B1 and B2. In the case where there is a plurality of first menu items in the non-select area, it is advantageous that a spacing gap between the first menu items is about 20 pixels. Specifically, if one of the first menu items is located on the main menu area 400, the main menu area 400 is an area which a highlight effect is generated. In addition, a non-select area located on at least one side of the select area A has opacity in order to distinguish it easily from the select area A. As one example, describing in reference to FIG. 6 and FIG. 7, each main menu item 420, 430, 440 located on the non-select area B2 has a different opacity with each other, respectively. Each main menu item 420, 430, 440 may have a smaller value of opacity as its distance from the select area A increases. Opacity in the present exemplary embodiment is about 60% in the “Sound” menu item 420, about 40% in the “Channel” menu item 430 and about 20% in the “Setup” menu item 440. Moreover, it is advantageous that the opacity for the spacing gaps between each of menu items is gradually changed according to opacity of each menu item.

The screen device 111 is a display device and displays menu items for an on screen display in graphic or text. Herein, an LCD (Liquid Crystal Display) panel or a CRT (Cathode Ray Tube), or other such device known in the art, may be used as the screen device 111. The input device 113 generates a cursor on the screen device 111, shifts the cursor between the menu items displayed on the screen and also selects a desired menu item.

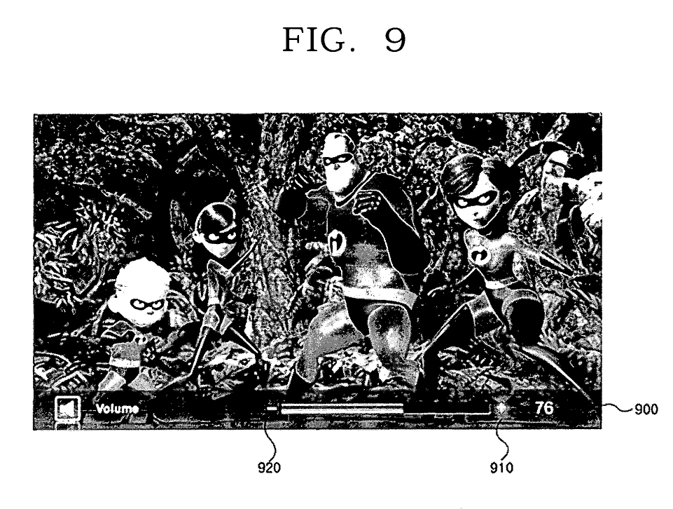

The control device 114 displays the main menu area 400 and the help area 500 on a portion of a background area 600 by using the system programs stored to the memory device 112 according to the signal from the input device 113. Preferably, control device 114 displays the main menu area 400 and the help area 500 translucently by overlapping on the background area 600. It is advantageous if the help area 500 is displayed translucently by overlapping a portion of the main menu area 400 and a portion of the background area 600, and it may be controlled that the help area 500 is not displayed according to a user's setting up. In addition, the control device 114 translucently overlaps for a portion which the help area 500 is superposed with the main menu area 400. Furthermore, the control device 114 performs a circular shift and shifts horizontally each of the first menu items according to a shift signal in order to select each of the first menu items using the input device 113. Selecting each of the first menu items, in order to represent second menu items, i.e. sub-menu items of each of the first menu items, the control device 114 displays the sub-menu area 700 on a portion of the background area 600. Likewise, it is advantageous if the control device 114 displays translucently the sub-menu area 700 by overlapping the sub-menu area 700 on the background area 600. Herein, if any one of the first menu items is selected by the signal from the input device 113, the control device 114 controls to fade-out a portion or all of the help area 500 and to fade-in second menu items for the selected the first menu items. In addition, if any one of the first menu items enters the select area A of the main menu area 400 according to the signal of the input device 113 and remains for a set time, the control device 114 controls that the icon of the corresponding the first menu items represents an animation effect and the text increases in luminance. Herein, it is advantageous if the set time is about 0.5 seconds. The control device 114 may also control to increase the brightness around the text. In addition, the control device 114 may control to show the effect of flickering by increasing and decreasing the brightness of the text or the area around the text repeatedly. In the same manner, the control device 114 may control to be able to increase the brightness of a number or a symbol beyond the text indicated on the screen of the screen device 111 according to the input signal of the input device 113, or may control to be able to increase the brightness for an area around the number or symbol. As an example, FIG. 9 is a diagram displaying that a user changes a setting of the volume using the input device 113. Herein, the brightness around at least one of an indicator or a “+” 910 symbol, a “−” 920 symbol indicated within a setting area 900 is changed according to the signal of the input device 113. As shown in FIG. 9, the control device 114 controls to increase the brightness around the “+” 910 symbol rising the volume according to the input signal of the input device 113.

Particularly, if any one of the first menu items enters the select area A of the main menu area 400 according to the signal of the input device 113 and remains for a constant time, the control device 114 controls that a highlight effect appears to the select area A. Herein, in order to represent the highlight effect, the control device 114 maximizes the luminance of the lower corner of the select area A and decreases gradually the luminance as going to the upper corner. Furthermore, in order to distinguish easily the non-select area from the select area A, by reading the data for each area from the memory device 112, the control device uses the data to control the opacity of the non-select areas B1 and B2. The control device may control that the main menu items which are located on the non-select area have a smaller value of opacity as their distance from the select area A increases.

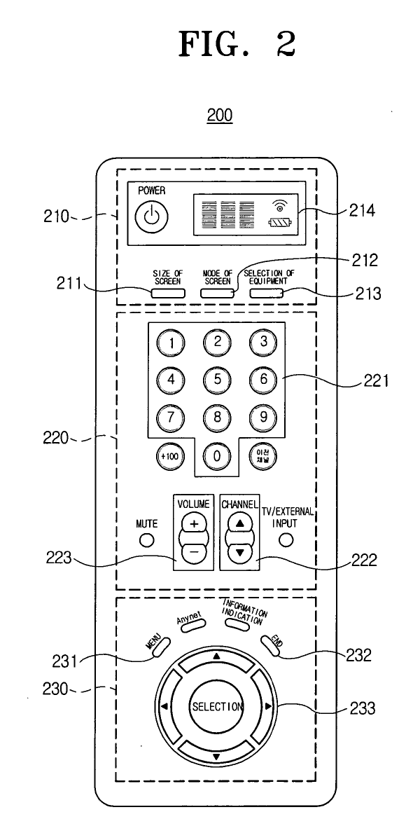

Hereinafter, a remote controller 200 as the above input device 113 will be described with reference to FIG. 2.

FIG. 2 shows a plan view of the remote controller 200 according an exemplary embodiment of the present invention. The remote controller 200 is mainly divided into three portions.

The first potion 210 is a portion for displaying an initial setting state and current setting state of a TV receiver 100 or a remote controller 200. Buttons corresponding to the first portion 210 include a screen size button 211 for adjusting the size of screen displayed on the screen device 111, a screen mode button 212 for selecting one of several modes for differentiating the quality of picture or definition in accordance with situations, a equipment selecting button 213 for operating equipment such as a VCR or a DVD player other than the TV receiver, etc. The first portion 210 is provided with an LCD portion 214 and thus a user can check the current equipment setting state.

The second portion 220 has buttons capable of setting basic functions of the TV receiver 100. The second portion 220 has digit buttons 221 and channel selecting button 222 for selecting or modifying channels and a volume button 223 for adjusting the sound volume of speaker 108, etc.

The third portion 230 has buttons regarding displaying and selecting of menu items.

The menu button 231 is a button for indicating menu items for an on screen display on the screen of the screen device 111 on which images are displayed. The button 231 displays a main menu area 400 including each of the first menu items when there are no menu items on the screen on which an image appears. If the menu items were displayed, the menu button 231 generally serves to as a.back button for returning to the previous screen. For example, if the menu button 231 is pushed under the state that the sub-menu area 700 including sub-menu items were displayed, the push of the menu button 231 would return to the state of the main menu area 400. If the menu button is pushed under the state that main menu area 400 was displayed, the push of the menu button 231 would return to the state that all the menu items have disappeared.

In case that the menu items were displayed, the end button 232 of the third portion 230 performs deleting all the menu items and displaying the normal screen regardless of whether the menu items are the main menu area 400 or the sub-menu area 700.

The shift and selecting button 233 of the third portion 230 generates a cursor among the menu items displayed on the screen and serves to shift it in the upper, lower, left and right directions and to select a menu item that user wants and designate a functional value of the selected menu item.

In the present exemplary embodiment, a remote controller is used as an input device, but a control panel attached integrally to the TV receiver 100 may also be used as the input device. Also, the input device may be a keyboard or mouse or other such input device known in the art connected to the TV receiver 100.

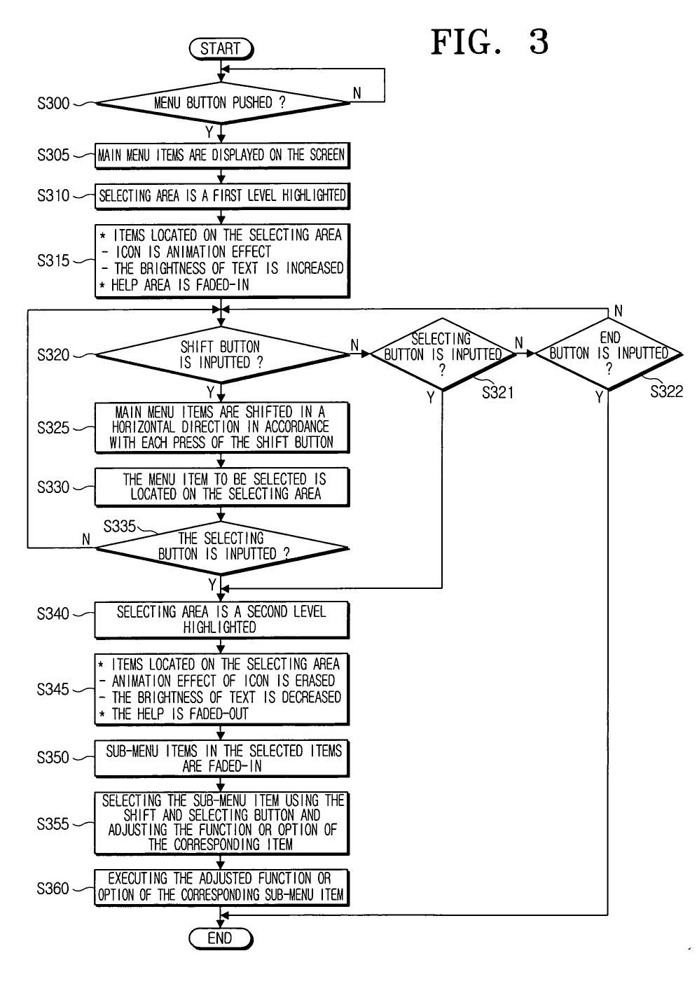

Now, a method of displaying the menu items according to an exemplary embodiment of the present invention will be described with reference to FIG. 3.

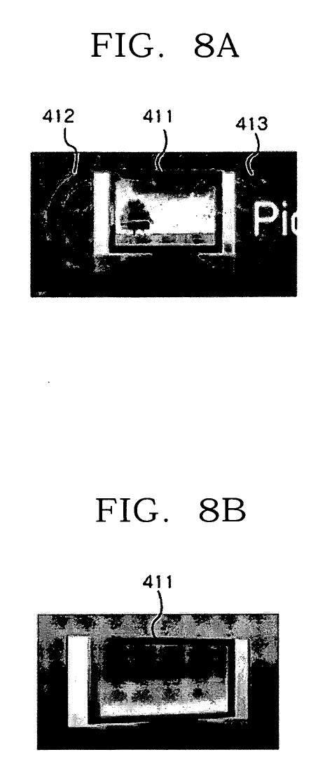

Firstly, the control device 114 in the TV receiver 100 checks whether or not a menu button 231 was pushed by the input device. Herein, the pushing of the menu button 231 does mean the state when the normal screen or initial screen was pushed. Also, the normal screen does mean the state that there is no menu item for on screen display. Then, the control device 114 determines that the menu button 231 was pushed, the first menu items, that is main menu items in the menu area 400 on the screen of the screen device 111 are displayed (operation S305). After a given time, a first level highlight effect in the selecting area A appears (operation S310). At the same time or immediately thereafter, icons of main menu items located on the selecting area A of the main area 400 among the main menu items are controlled to show an animation effect and the text is controlled to increase the brightness thereof (operation S315). As one example, as shown in FIG. 8B, if the main menu item 430 called “Picture” is located on the selecting area A, the selecting area A allows a first level highlight effect to appear by gradually decreasing the brightness of the lower end portion. Herein, as the animation effects for “Picture” icon 411, there may be several effects such as periodically generating predetermined circles 412 and 413 around the icon 411 or changing the phase of the icon 411 in order to give a perspective sense as shown in FIG. 8B, or other animation effect known in the art. The animation effect for each icon of the main menu items may be different depending upon the respective main menu item. If the help is preset to appear, the help area 500 is displayed overlapped with the background area 600 and the main menu area 400. The portion where the help area 500 overlaps with the main menu area 400 is transparently overlapped.

Thereafter, a determination is made as to whether the shift and selecting button 233 was pushed or an end button 232 was pushed (operations S320˜S322). If the shift button was pushed, the main menu items are shifted horizontally in the left or right direction in accordance with each depression of the of the shift button (operation S325). The main menu item to be selected is located on the selecting area A (operation S330) and then a determination is made as to whether or not the selecting button is inputted (operation S335).

If the selecting button is inputted, a second level highlight effect appears in the selection area A in the same way as the above first level highlight effect (operation S340). The second level highlight appears darker compared to the first level highlight. At the same or immediately thereafter, the animation effect of the corresponding icon in the main menu items located in the selecting area A and the brightness of the corresponding text disappears (operation S345). Further, if the help area 500 is in the state which was displayed overlapped with the background area 600 and the main menu area 400, the help area 500 is faded-out in operation 345. Also, almost simultaneously, the second menu area 700 including sub-main items of the selected first main menu items is faded-in and displayed (operation S350). Thereafter, the user selects the sub-menu item using the shift and selecting button 233 and adjusts the function or option of the corresponding item (operation S335).The control device 114 controls the adjusted function or option to be executed.

In operation S320, even though the selecting button is pushed without inputting the shift button (operation S321),the same operation is performed thereafter.

In the meantime, in operation S322, if an end button 232 is pushed without any input of the shift and selecting button 233, the menu items that were displayed are erased and the operation forwards to the end. That is, a function for displaying the normal screen is performed. Herein, if the menu items were displayed, the end button 232 erases all menu items regardless of whether the menu items are in the main menu area 400 or the sub menu area 700.

As described above, according to an exemplary embodiment of the present invention, a user can easily select the menu items that he wants by selecting a menu item with icon and text depending upon its characteristics. Further, a concentration power for the menu items to be selected can be increased by providing an animation depending upon the characteristics of respective icons and increasing the brightness of respective text.

Also, by allowing the corresponding helps for respective menu area to be provided, even a user who firstly tries to use the function or option of image equipment can conveniently operate them.

Specifically, a user can easily recognize the selecting area by the provided highlight effect for gradually decreasing the brightness toward the upper end portion, while maintaining the brightness of the lower end portion of the selecting area at maximum so that among main menu areas, the selecting area can easily be differentiated from the non-selecting area.

Further, by allowing respective menu areas and menu items which are displayed on the screen to be indicated semi-transparently, a user can view the image on the screen even when he sets the function or option of menu items.

Having described exemplary embodiments of the invention with reference to the accompanying drawings, it is to be understood that the invention is not limited to those precise embodiments. Various changes and modifications may be effected therein by one skilled in the art without departing from the scope or spirit of the invention as defined in the appended claims.

What is claimed is:

1. An on screen display apparatus comprising:
a memory device which is configured to store data and system programs for a first area, the data including a plurality of a first menu items;
a screen device which is configured to display said first area;
an input device which is configured to generate a signal to display said first area to said screen device; and
a control device which is configured to divide the first area into a first sub-area and a second sub-area using said system programs according to said signal, and to display the first sub-area more brightly than the second sub-area on said screen device, if at least one of the plurality of the first menu items is located in said first sub-area.

2. The apparatus according to claim 1, wherein said control device displays help for the at least one first menu item which is located in said first sub-area.

3. The apparatus according to claim 2, wherein the control device displays the help by translucently overlapping a portion of a help area with a main menu area.

4. The apparatus according to claim 1, wherein said control device displays at least one sub-menu item for the at least one first menu item which is located in said first sub-area.

5. The apparatus according to claim 1, wherein the control device displays the at least one sub-menu item by overlapping a sub-menu area on a background area.

6. The apparatus according to claim 1, wherein said control device shifts said plurality of the first menu items according to a shift signal of said input device.

7. The apparatus according to claim 6, wherein said control device shifts said plurality of the first menu items horizontally.

8. The apparatus according to claim 1, wherein said control device displays the at least one first menu item which is located in said first sub-area with animation effects.

9. A method for displaying menus of an on screen display apparatus comprising:
storing data and system programs for a first area, the data including a plurality of a first menu items;
generating a signal; and
dividing said first area into a first sub-area and a second sub-area according to said signal and displaying the first sub-area more brightly than the second sub-area if at least one of the plurality of the first menu items is located in said first sub-area.

10. The method according to claim 9, further comprising:
displaying help for the at least one first menu item which is located in said first sub-area.

11. The method according to claim 10, wherein the help is displayed by translucently overlapping a portion of a help area with a main menu area.

12. The method according to claim 9, further comprising:
displaying at least one sub-menu item for the at least one first menu item which is located in said first sub-area.

13. The method according to claim 12, wherein the at least one sub-menu item is displayed by translucently overlapping a sub-menu area on a background area.

14. The method according to claim 9, further comprising:
shifting said plurality of the first menu items according to a shift signal of said input device.

15. The method according to claim 14, wherein the plurality of first menu items are shifted horizontally.

16. The method according to claim 14, wherein the shifting occurs after displaying said first area.

17. The method according to claim 9, further comprising:
displaying the at least one first menu item which is located in said first sub-area with animation effects.
